(19) United States
(12) Patent Application Publication
(10) Pub. No.: US 2008/0176201 A1
(43) Pub. Date: Jul. 24, 2008

(54) USER INTERFACE FOR AN AUDIO BOOK PLAYER

(75) Inventors: Gilles Pepin, St-Charles de Drummondville (CA); Alain Pare, Kirkland (CA); Dominic R. Labbe, McMasterville (CA); Gerard M. Chevalier, Edmonton (CA); Joseph A. Juratovac, Columbus, OH (US); Jeffrey R. Held, Columbus, OH (US); Shannon M. Hoste, Westerville, OH (US); Gregg Charles Vanderheiden, Madison, WI (US); Frank Kurt Cylke, Great Falls, VA (US); Jean Marie Moss, Glendale, MD (US); Michael Gilbert Katzmann, Washington, DC (US); Robert Edward Fistick, Charlotte Hall, MD (US); Michael Montfort Moodie, Bethesda, MD (US); Alice Kathryn Baker, Washington, DC (US)

Correspondence Address: MYERS BIGEL SIBLEY & SAJOVEC, PO BOX 37428, RALEIGH, NC, 27627, US

(73) Assignees: TECHNOLOGIES HUMANWARE CANADA INC.; WISCONSIN ALUMNI RESEARCH FOUNDATION

(21) Appl. No.: 11/857,585

(22) Filed: Sep. 19, 2007

Related U.S. Application Data
(60) Provisional application No. 60/845,775, filed on Sep. 20, 2006.

(51) Int. Cl. G09B 5/00

(52) U.S. Cl. 434/317

(57) ABSTRACT

A user interface for an audio book player is provided. The user interface includes a number of primary keys for accessing primary functions of the player, the primary keys disposed in a primary zone of a top surface of the player, a number of secondary keys for accessing secondary functions of the player, the secondary keys disposed in a secondary zone of the top surface, and a tactile separation element separating the primary zone from the secondary zone. Each of the primary and secondary keys may have a specific tactilely-recognizable shape and label associated with it.

### CROSS-REFERENCE TO RELATED APPLICATIONS

This application claims priority to U.S. Provisional Application Ser. No. 60/845,775, filed Sep. 20, 2006, the disclosure of which is incorporated by reference in its entirety.

### RIGHTS IN THE INVENTION

This invention was made, in part, with funding from the United States Government under Award No. GS-23-F0011L and, accordingly, the United States Government may have certain rights in this invention.

### FIELD OF THE INVENTION

The present invention relates to the field of audio books and more particularly concerns a user interface for an audio book player designed for optimal interaction with visually impaired, physically disabled and learning disabled users.

### BACKGROUND OF THE INVENTION

“Audio” or “talking” books are an important alternative format to print for providing access to books of all types for print-disabled persons who cannot read conventional print books due to a visual, physical or learning disability. The contents of a print document, in its entirety or abridged, is usually read by a professional or a volunteer and recorded on a medium appropriate for distribution, such as a tape cassette or a CD. With recent improvements in digital memory devices, the talking book industry now uses low cost digital media such as Flash memory devices for storing their products.

The expression “print-disabled persons” designating the target users of audio books refers to users who may have a wide variety of conditions preventing them from enjoying conventional print books, such as for example blind or low vision users, users with cognitive difficulties; users with a physical disability preventing or impairing the use of their hands, users with arthritis, elderly users, users with cerebral palsy, users with multiple sclerosis, etc. Ideally, audio book players should be adapted so as to be user-friendly and convenient for any print-disabled user, no matter the condition they are affected by. In particular, an audio book player should have a user interface through which print-disabled users may easily control the different operating functions of the device. A variety of such interfaces exist, each with its own advantages and drawbacks. There is however still a need for an optimal design for a user interface of an audio book player.

### SUMMARY OF THE INVENTION

In accordance with one aspect of the present invention, there is provided a user interface for an audio book player having a top surface and a bottom surface opposite the top surface. The user interface includes a plurality of primary keys for accessing primary functions of the audio book player, the primary keys disposed in a primary zone of the top surface of the audio book player, a plurality of secondary keys for accessing secondary functions of the audio book player, the secondary keys disposed in a secondary zone of the top surface of the audio book player, and a tactile separation element separating the primary zone from the secondary zone of the audio book player.

The primary zone is preferably located below said secondary zone.

The plurality of primary keys may include at least one of a Play/Stop key, Rewind key or Fast Forward key. The plurality of primary keys may further include at least one of a Power ON/OFF key, Volume Down key, Volume Up key or Sleep key.

The plurality of secondary keys may include at least one of a Tone Down key, Tone Up key, Speed Down key or Speed Up key. The plurality of secondary keys may further include at least one of a Bookmark key, Navigation Menu key, Previous key, Next key or Information key.

The plurality of primary keys and the plurality of secondary keys are preferably raised with respect to the top surface of the audio book player.

Each of the primary keys may be defined by a specific tactilely-recognizable shape, the specific tactilely-recognizable shape corresponding to a primary function associated with the corresponding primary keys. Similarly, each of the secondary keys may be defined by a specific tactilely-recognizable shape, the specific tactilely-recognizable shape corresponding to a secondary function associated with the corresponding secondary keys.

The user interface for an audio book player may further include a plurality of labels each associated with one of the primary keys or secondary keys.

Preferably, the primary keys all have a same specific color and the secondary keys all have a different same specific color thereby visually distinguishing said primary keys from said secondary keys.

Other features and advantages of the present invention will be better understood upon reading of preferred embodiments of the invention with reference to the appended drawings.

### BRIEF DESCRIPTION OF THE DRAWINGS

FIG. 1A is a perspective top view of a standard user interface for an audio book player according to one embodiment of the invention.

FIG. 1B is a perspective top view of an advanced user interface for an audio book player according to another embodiment of the invention.

FIG. 2A is a top view of the user interface for an audio book player shown in FIG. 1A.

FIG. 2B is a top view of the user interface for an audio book player shown in FIG. 1B.

FIG. 3 is a top view of a user interface for an audio book player, according to one embodiment.

### DESCRIPTION OF PREFERRED EMBODIMENTS OF THE INVENTION

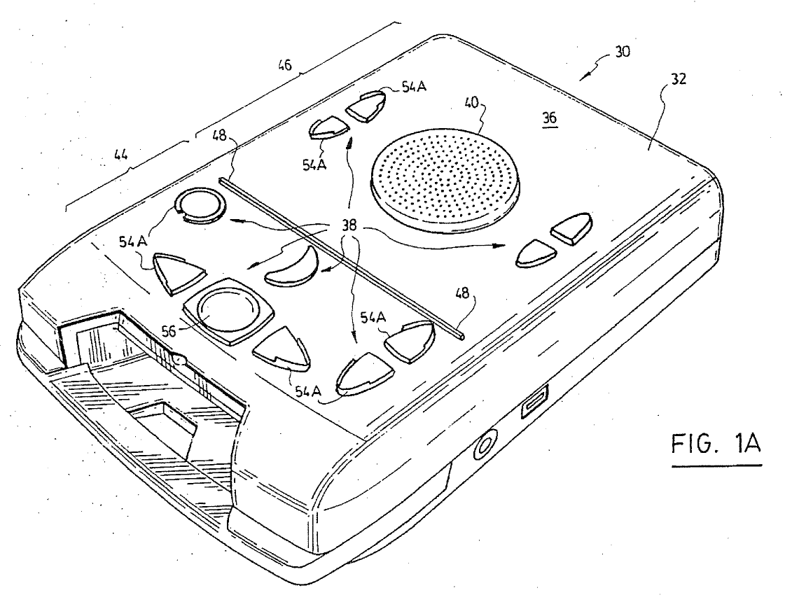

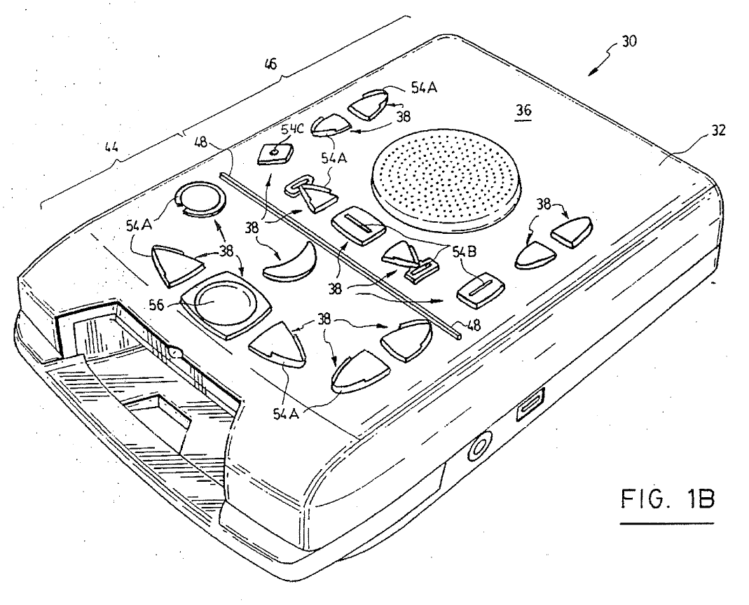

Referring to FIGS. 1A, 1B, 2A, 2B, and 3, there are shown audio book players 30 provided with user interfaces 32 according to preferred embodiments of the invention.

The present invention concerns a player for “audio” or “digital talking” books. It is understood that the expressions “audio book” or “digital talking book” are used herein indiscriminately to refer to any voice or other audio recording appropriate for distribution to print-disabled users. For example, and not exhaustively, the recorded information may be a literary work, reference work, school book, children's book, non-fiction book, compilation, newspaper or magazine articles, or even music, radio recording, video, text, maps, biometric data or other types of recorded audio material. In the present invention, the recording is provided in a digital format and may have been created by any appropriate technique known in the art, such as for example by recording of an audio file using a Text-To-Speech (TTS) input or by rendering of text files using a TTS engine embedded in the player.

The recording is preferably provided on a digital storage media packaged in a cartridge. In the preferred embodiment, the cartridge and player are designed with features facilitating their use by the print-disabled. Such a cartridge and player system is for example shown in provisional application No. 60/845.763 entitled “DIGITAL AUDIO BOOK CARTRIDGE AND PLAYER WITH MANIPULATION-FACILITATING FEATURES”. However, it will be readily understood by one skilled in the art that the user interface of the present invention could equally be used with systems of a different type, for example with systems based on analog or digital recording media such as tape cassettes, CDs, SD cards, USB drives or flash memory, or systems which receive the audio files through other means such as a wired connection to a PC or wireless connection to the Internet.

As mentioned above, the present invention is particularly directed to facilitating the use of an audio book player by disadvantaged users who are either visually impaired, learning disabled or have one or more physical disabilities. This group is collectively referred to herein as “print-disabled users” and includes blind or low vision users, users with cognitive difficulties, users with perceptual or learning disabilities; users with a physical disability preventing or impairing the use of their hands, users with arthritis, elderly users, users with cerebral palsy, users with multiple sclerosis, etc. It will be understood by one skilled in the art that this list is non-exhaustive and that a given print-disabled user may be affected by one or a combination of the disadvantages listed above or others.

In accordance with one aspect of the present invention, there is provided a user interface 32 for an audio book player 30. The user interface 32 includes a plurality of keys 38 on a top surface 36 of the audio book player 30, separated into two groups defined as primary and secondary keys. The primary keys provide access to functions of the player 30 that are used most frequently and are disposed in a primary zone 44, preferably located in a lower portion of the top surface 36 of the player 30. The secondary keys provide access to functions of the player which are used less frequently, and are disposed in a secondary zone 46 of the top surface 36 positioned above the primary zone 44. A tactile separation element 48 is provided on the top surface of the player dividing the primary and secondary zones (44 and 46, respectively).

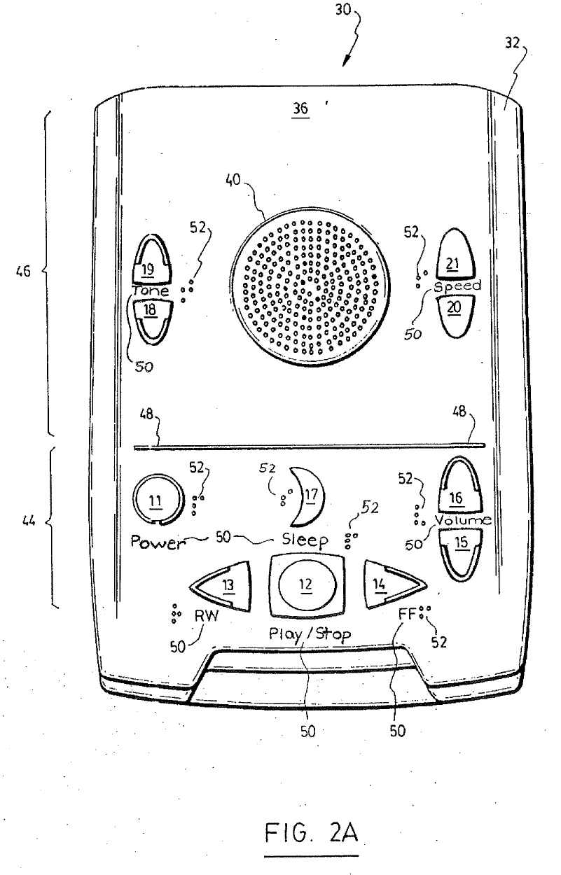

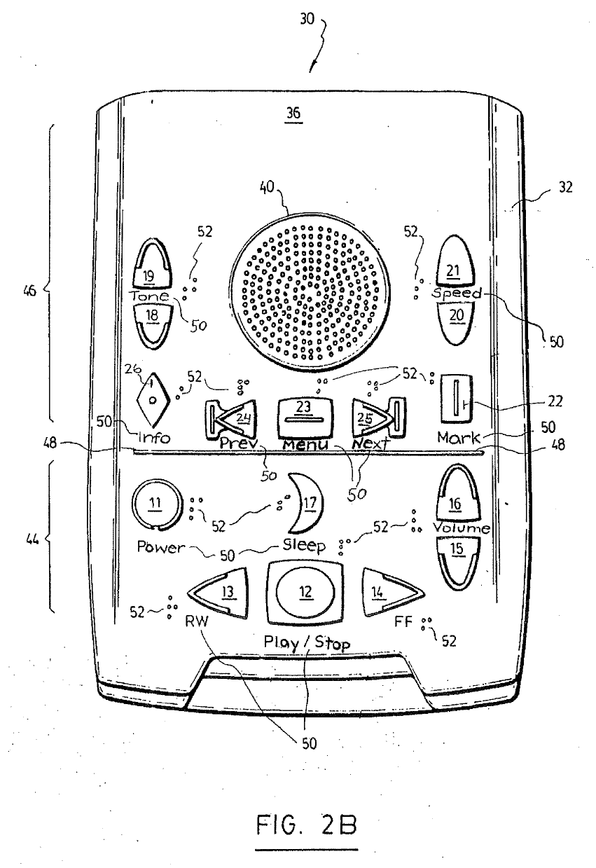

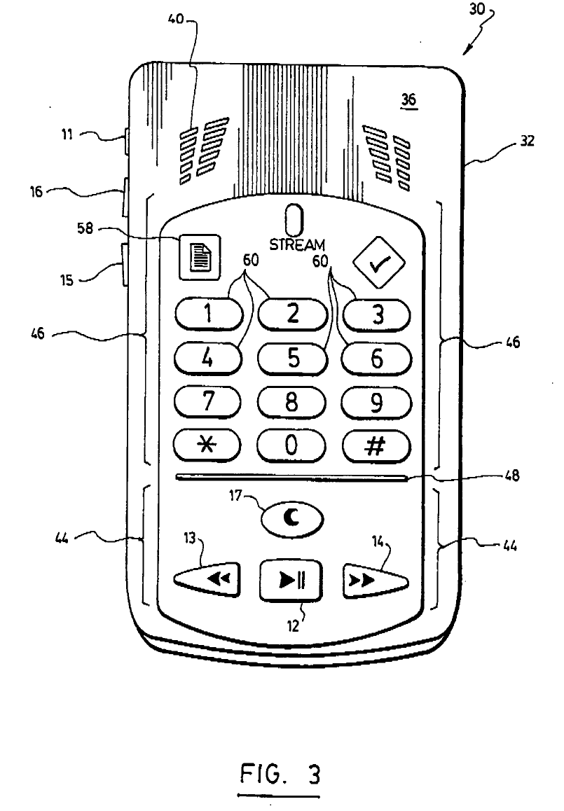

It will be noted that by way of example, three models of players of different levels of complexity in the user interface are shown in the accompanying drawings. The player 30 of FIG. 1A and FIG. 2A is called the “standard” model and provides a limited number of functions accessible by the user. The “advanced” model, shown in FIG. 1B and FIG. 2B, provides access to a greater number of functions as will be explained further below. The hand-held model shown in FIG. 3 provides a user-interface which includes a combination of functions suited for the size and portability of this player.

In accordance with one aspect of the invention, the user interface 32 therefore includes a plurality of keys 38 distributed on the top surface 36 of the player 30. Preferably, the keys 38 are raised with respect to the top surface 36 of the player 30 thereby making it easier for a print-disabled person to tactilely locate the keys. The keys 38 provide access to the operating functions of the player 30, that is, pressing on one key will activate the function associated with this particular key.

The keys 38 are separated on the top surface 36 of the player 30 into two groups, defined as the primary keys and secondary keys.

The primary keys provide access to primary functions of the player 30, that is, those functions that are used most frequently. In the preferred embodiments shown in FIGS. 2A, and 2B, the primary keys include: Power ON/OFF key 11, Play/Stop key 12, Rewind key 13, Fast Forward key 14, Volume Down key 15, Volume Up key 16, and Sleep key 17. It will be noted that these functions are common to both the standard and advanced player models shown in FIGS. 1A, 1B, 2A, and 2B.

In accordance with the non-limitative embodiments of the invention shown in FIGS. 1A, 1B, 2A, and 2B, these functions are embodied as follows:
Power ON/OFF: Pressing the Power ON/OFF key 11, toggles between powering on and off the player.
Play/Stop: Pressing the Play/Stop key 12 starts or stops playing a book. When the book or any audio message is playing, pressing this key will make it stop. If this key is pressed again, the book will begin playing where it last stopped. Preferably in the standard model embodiment, pressing and holding the Play/Stop key for a preset time, say 2 seconds, provides access to a player User Guide.
Rewind: Pressing the Rewind key 13 once moves backward 5 seconds in the book. Pressing and holding this key down moves further backward in the book. The player preferably indicates how far back into the book it is moving. For example, holding the Rewind key for 15 seconds will back up 15 minutes in the book. If this key is held longer than 15 seconds, the player will begin jumping from one chapter to the previous chapter. It will beep at the start of each chapter. If the Rewind key is held long enough, the player will reach the beginning of the book. In accordance with one embodiment of the player, the longer the key is held down, the more quickly the player moves backward. When the Rewind key is released, the player announces the name of the chapter that was reached and starts playing from the beginning of that chapter. If the player was stopped before the Rewind key was pressed, the Play/Stop key must be pressed to begin playing.
Fast Forward: Pressing the Fast Forward key 14 once moves forward 5 seconds in the book. Pressing and holding this key down moves further ahead in the book. For example, if the Fast Forward key is held for 15 seconds, the player will advance 15 minutes in the book. If this key is held longer than 15 seconds, the player will begin jumping from one chapter to the next chapter. It will beep at the start of each chapter. If the Fast Forward key is held long enough, the end of the book will be reached. In accordance with one embodiment, the longer the Fast Forward key is held down, the more quickly the player moves forward. When the Fast Forward key is released, the player will announce the name of the chapter that was reached and start playing from the beginning of that chapter. If the player was stopped before the Fast Forward was pressed, it the Play/Stop key must be pressed to begin playing.
Volume Down: Pressing the Volume Down key 15 decreases the volume by one step. In the preferred embodiment, there are 15 Volume steps, and the volume cannot be turned off completely.
Volume Up: Pressing the Volume Up key 16 increases the volume by one step. In the preferred embodiment, there are 15 Volume steps. Advantageously, a personalized safe maximum level is also defined to prevent hearing damage from an excessive volume level.
Sleep: Pressing the sleep key 17 causes the player to play for a preset time of say 15 minutes, and then stop. Pressing this button at any time will reset the play time back to 15 minutes.

It will be understood that the functions listed above have been identified as “primary functions” in the illustrated embodiment since they have been observed to be the most commonly used in typical audio book players. It will however be understood that the primary functions may include more or less functions than those listed above or be embodied by an altogether different set of keys depending on the target users, type of audio material, underlying technology, etc. For example, in the embodiment shown in FIG. 3, the Power ON/OFF key 11, Volume Up key 16 and Volume Down key 15, are not located in the primary zone 44, wherein are located the Sleep key 17, Play/Stop key 12, Rewind key 13 and Fast Forward key 14, but are positioned on a side of the player 30, for example at the top of the left side of the player 30. In addition, some of the functions listed above may be combined in a single key or oppositely, spread to more than one key. For example, the Play and Stop functions may be embodied by different separate keys whereby pressing the Play key controls book play as described above and pressing the Stop key causes the player to stop book play. In another example, key pairs such as Volume Up/Down keys or Rewind/Fast Forward keys may be each regrouped in a single key, say a three-way toggle key or any other appropriate key.

It will be further understood that the primary keys may be arranged in any convenient manner within the confines of the primary zone, and that the distribution shown in the accompanying drawings is given only as an example.

The secondary keys provide access to secondary functions of the player, that is, those functions which are used less frequently. The secondary functions therefore preferably include all the functions provided on the player which are not identified as “primary” functions. In the standard model embodiment, shown in FIG. 1A and FIG. 2A, these secondary keys include Tone Down key 18, Tone Up key 19, Speed Down key 20 and Speed Up key 21. The secondary keys may further include, as shown in the advanced model embodiment of FIG. 1B and of FIG. 2B, a Bookmark key 22, a Navigation Menu key 23, Previous key 24 and Next key 25 and an Information key 26. Other embodiments, for example the hand-held model shown in FIG. 3, may also further include at least one of a ‘Go to Page’ key (58) and numerical keypad keys (60).

It will be understood by one skilled in the art that the player 30 may be provided with a variety of other primary and secondary keys and corresponding functions in addition or in replacement of those listed here.

Again according to the non-limitative embodiments of the invention shown in FIGS. 1A, 1B, 2A, and 2B, these functions are embodied as follows:
Tone Down: Pressing the Tone Down key 18 lowers the Tone of the audio voice by one step. There are preferably a maximum of 11 Tone steps. The player audibly indicates when a maximum, normal, or minimum Tone has been reached.
Tone Up: Pressing the Tone Up key 19 key raises the Tone of the voice by one step. There are preferably a maximum of 11 Tone steps. The player audibly indicates when a maximum, normal, or minimum Tone has been reached.
Speed Down: Pressing the Speed Down key 20 decreases the reading speed by one step. There are preferably a maximum of 16 Speed steps. The player audibly indicates when a maximum, normal, or minimum speed has been reached.
Speed Up: Pressing the Speed Up key 21 increases the reading speed by one step. There are preferably 16 Speed steps. The player audibly indicates when a maximum, normal, or minimum speed has been reached.
Bookmark: While reading a book or in a stop mode, pressing the Bookmark key 22 sets a bookmark at the current reading position. Pressing the Bookmark key within a short period of time of a bookmark insertion, say 5 seconds of a bookmark insertion, will delete this bookmark. If the Navigation Menu is set to Bookmark List, a bookmark can be selected by pressing the Previous key 24 or Next key 25 to browse through the Bookmark list. Once the desired bookmark is reached, the said bookmark can be deleted by pressing the Bookmark key. Pressing the Bookmark key within a short period of time of a bookmark deletion, within say 5 seconds of a bookmark deletion, will reinsert this bookmark.
Navigation Menu: Pressing the Navigation Menu key 23 repeatedly allows the selection of the type of navigation in a book, such as chapter, section, page, one-minute segment or by bookmark. The menu may have different choices for each book. Once a navigation level has been selected, the Previous key 24 and Next key 25 can be used to navigate within that selection. For example, if the chapter type is selected, then the Previous Item button will move backward a chapter at a time and the Next Item button will move forward a chapter at a time.
Previous: Each time the Previous key 24 is pressed, the player moves to the previous item in the selected navigation level. For example, if the chapter level is selected from the Navigation Menu, then each time the Previous key is pressed the player will move to the beginning of the previous chapter. Similarly, if the section or bookmark level is selected, pressing the Previous key moves backward through each section or bookmark. Pressing and holding this key moves backwards in the book in steps of five (5) or ten (10) items at a time in the selected navigation level. Regardless of the chosen navigation level, pressing the Previous key will eventually bring the player to the beginning of the book.
Next: Each time the Next key 25 is pressed the player moves to the next item in the selected navigation level. For example, if the chapter level is selected from the Navigation Menu then each time the Next key is pressed the player will move to the beginning of the next chapter. Similarly, if the section or bookmark level is selected, pressing the Next key moves forward through each section or bookmark. Pressing and holding this key moves ahead in the book in steps of five (5) or ten (10) items at a time in the selected navigation level. Regardless of the chosen navigation level, pressing the Next key will eventually bring the player to the end of the book.
Information: Pressing the Information key 26 provides information about the current reading position, battery status, and power-plug status. Repeatedly pressing this key steps through these information items. Pressing and holding the Information key also plays the built-in User Guide. The User Guide can be exited by pressing and holding the Information key again.

The primary keys for accessing primary functions of the audio-book player 30 are disposed in a primary zone 44 of the top surface 36 of the audio-book player 30. The primary zone 44 occupies a suitable portion of the length of the top surface 36 of the player 30, and other proportions than those illustrated in the drawings could be considered. The primary keys are preferably distributed over the primary zone 44 in an arrangement facilitating their use.

For example, in the illustrated embodiments of FIGS. 2A and 2B, the Power key 11 is in the upper left corner of the primary zone 44; the Volume Up and Down keys 16 and 15 are positioned one above the other on the right side of the primary zone 44; the Rewind key 13, Play/Stop key 12 and Fast Forward key 14 are arranged in a line a the bottom of the primary zone 44; and the Sleep key 17 is positioned directly above the Play/Stop key 12. In another embodiment (not shown), the Power ON/OFF key may be located in an upper right corner of the primary zone, the Volume Down and Volume Up keys may be located one above the other on a left side of the primary zone, the Rewind, Play/Stop, and Fast Forward keys may be arranged in a line at a bottom of the primary zone, and the Sleep key may be located above the Play/Stop key.

The secondary keys for accessing secondary functions of the audio-book player 30 are disposed in a secondary zone 46 of the top surface 36 of the audio-book player 30. The secondary zone 46 is preferably positioned above the primary zone 44. In the illustrated embodiments of FIGS. 1A, 1B, 2A, and 2B, the secondary zone 46 occupies the remaining two thirds of the top surface 36. Also in the illustrated embodiments, the audio speaker 40 of the player 30 is positioned within the secondary zone 46, but it could be positioned in any other appropriate location as will be readily understood by one skilled in the art.

Referring to FIG. 1A and FIG. 2A, in the illustrated embodiment of the standard model of the player 30, the Tone Up and Tone Down keys 19 and 18 are positioned one above the other on the left side of the secondary zone 46, and the Speed Up and Speed Down keys 21 and 20 are similarly disposed on the right side, preferably in alignment with the Tone keys 19 and 18. These keys also occupy the same positions in the illustrated embodiment of the advanced model of the player 30, shown in FIG. 1B and in FIG. 2B. In this embodiment of the advanced model, the Previous key 24, Menu key 23 and Next key 25 are disposed centrally and in a line at the bottom of the secondary zone 46. The Bookmark key 22 is provided at the right bottom corner of the secondary zone 46, whereas the Information key 26 is placed at the left bottom corner of the secondary zone 46. In another embodiment (not shown) of the standard or advanced model of the player, the Tone Up and Tone Down keys may be positioned one above the other on the right side of the secondary zone, and the Speed Up and Speed Down keys may be similarly disposed on the left side, preferably in alignment with the Tone keys. In addition or alternatively, in the advanced model, the Previous key, Menu key and Next key may be disposed centrally and in a line at the bottom of the secondary zone while the Bookmark key may be disposed at the left bottom corner of the secondary zone and the Information key may be disposed at the right bottom corner of the secondary zone. As for the primary keys, the secondary keys may be arranged in any appropriate manner within the secondary zone. Of course, numerous such arrangements are possible.

The user interface 32 further includes a tactile separation element 48 separating the primary zone 44 from the secondary zone 46 of the audio-book player 40. The separation element 48 provided on the top surface 36 of the audio book player 30 marks the border between the primary zone 44 and the secondary zone 46.

Any structure allowing a user to recognize the separation between the primary and secondary zones (44 and 46) through tactile sensations can embody the tactile separation element 48. In the embodiments illustrated in the accompanying drawings, the separation element 48 is embodied by a thin ridge extending across a substantial portion of the width of the player 30. The tactile separation element 48 may be a raised ridge of any appropriate thickness protruding from the top surface 36 of the audio book player 30. Alternatively, the tactile separation element 48 may be a recessed ridge in the top surface 36 of the audio book player 30. It will be understood that the tactile separation element 48 could have a variety of profiles, and need not be uniform as in the illustrated embodiment. It could for example be discontinuous, have a thickness or height which varies along the player, etc. The tactile separation element 48 could also have a different texture than the top surface 36 of the player 30 or be made from a different material. It may be an element moulded as part of the player, affixedly added to the player afterward or a combination of both.

The key design of the player 30 may be optimized for facilitating key recognition and proper use by any of the targeted print-disabled user group.

Referring more specifically to FIGS. 1A and 1B, the primary and secondary keys may be raised with respect to the top surface 36 of the player 30. Moreover, the primary and secondary keys may be defined by a specific tactilely-recognizable shape, the specific tactilely-recognizable shape corresponding to a primary or secondary function associated with the corresponding keys. Preferably, the profile of each key is slightly rounded in order to avoid sharp edges.

In one embodiment of the invention, the primary and secondary keys of the player 30 may further include a tactile marking on a surface of at least a portion of the keys of the player. The tactile markings are selected so that each key is different from the others. Preferably, the tactile markings include a raised ridge 54A, on the surface of the corresponding key, which outlines the specific tactilely-recognizable shape of the corresponding key or a portion thereof, generally reproducing the functional shape of the key. For some keys, the raised ridge may follow the edge of the key so that a finger locating the key from the outside will immediately encounter the ridge, facilitating key recognition. In other cases, an inner ridge 54B may be provided inward of the surface of the key to differentiate it from others. The tactile marking may further include a particular profile of the surface of the key, such as a rounded recess 56 in the key. Additionally, the tactile marking may include a raised dot 54C in the middle of the Information key 26 allowing a print-disabled person to quickly identify the key and access its helpful information and to orient the other keys with respect to the Information key.

Optionally, a number of labels associated with any of the primary and secondary keys may be provided on a top surface 36 of the player 30, as best shown in FIGS. 2A and 2B. The label may be tactile including a raised or recessed symbol or Braille symbols 52. The Braille symbols 52 are preferably limited to a few letters, owing to the limited space on the top surface of the player. The tactile label may also include visually-recognizable information such as print text 50. Preferably, the print text 50 is in a large title case font. When present, both print and Braille labels are positioned so as to be clearly associated with the target key. A single label of each type may be provided for pairs of keys associated with the “Up” and “Down” options of a same function.

Preferably, the key design also includes a color code associated with said keys. In one embodiment, the primary keys may all have a same specific color and the secondary keys may all have a different same specific color thereby visually distinguishing the primary keys from said secondary keys. The primary keys which are used more frequently preferably have a color associated with them that is brighter than that of the secondary keys which are used less frequently, thereby drawing attention to the primary keys. Alternatively, the primary keys and the secondary keys may each have a specific color where the specific color corresponds to a function associated with each of the primary and secondary keys. In one embodiment of the user interface, the secondary keys may have a light neutral color contrasting with the body of the player itself, while certain individual primary keys may have different bright colors associated with their function: red for the Power ON/OFF function, green for the Play/Stop function and yellow for the Volume controls. The color or colors for the other keys may for example be chosen to maximise the visual contrast between these keys and the top surface of the player.

For one embodiment of the user interface associated with the standard player model as described hereinabove, the keys have the characteristics listed in the following Table I:

TABLE I

| Function | Shape | Color | Tactile | Print | Braille |
|---|---|---|---|---|---|
| Power | Circle | Red | Concave circular dish | Power | p |
| | | | key with raised ridge | | |
| | | | around | | |
| | | | the key | | |
| Play/Stop | Largest key, | Green | Concave oval dish | Play/Stop | p |
| | horizontal | | (recess) | | |
| | rectangle | | | | |
| Rewind | Left pointing | Light | Raised edge on left | RW | r |
| | triangle | Grey | point | | |
| Fast | Right pointing | Light | Raised edge on right | FF | f |
| Forward | triangle | Grey | point | | |
| Volume | Downward pointing | Yellow | Raised edge on bottom | Volume | v |
| Down | elliptical triangle | | rounded point | | |
| | with rounded | | | | |
| | summit | | | | |
| Volume | Upward pointing | Yellow | Raised edge on top | Volume | v |
| Up | elliptical triangle | | rounded point | | |
| | with rounded | | | | |
| | summit | | | | |
| Sleep | Crescent shape | Light | None | Sleep | s |
| | open to the left | Grey | | | |
| Tone | Downward pointing | Light | Raised edge on bottom | Tone | t |
| Down | elliptical triangle | Grey | rounded point | | |
| | with rounded | | | | |
| | summit | | | | |
| Tone Up | Upward pointing | Light | Raised edge on top | Tone | t |
| | elliptical triangle | Grey | rounded point | | |
| | with rounded | | | | |
| | summit | | | | |
| Speed | Downward pointing | Light | None | Speed | s |
| Down | elliptical triangle | Grey | | | |
| | with rounded | | | | |
| | summit | | | | |
| Speed Up | Upward pointing | Light | None | Speed | s |
| | elliptical triangle | Grey | | | |
| | with rounded | | | | |
| | summit | | | | |

For another embodiment of the user interface associated with the advanced player model described hereinabove, the keys have the characteristics listed in Table II in addition to those listed in Table I:

TABLE II

| Function | Shape | Color | Tactile | Print | Braille |
|---|---|---|---|---|---|
| Bookmark | Vertical | Light | Raised vertical bar | Mark | b |
| | rectangle | Grey | | | |
| Navigation | Horizontal | Light | Horizontal raised bar | Menu | m |
| Menu | rectangle | Grey | | | |
| Previous | Left pointing | Light | Raised “K” shape | Prev | p |
| | arrow | Grey | marking over the | | |
| | intersecting a | | vertical bar and arrow point | | |
| | thick vertical bar on | | | | |
| | the left | | | | |
| Next | Right pointing | Light | Reversed raised “K” | Next | n |
| | arrow | Grey | shape marking over | | |
| | intersecting a | | the vertical bar and arrow | | |
| | thick vertical bar | | point | | |
| | on the right | | | | |
| Information | Diamond | Light | Raised dot in center | Info | i |
| | | Grey | | | |

Of course, numerous modifications could be made to the embodiments above without departing from the scope of the present invention.

1. A user interface for an audio book player directed to print-disabled persons, said audio book player having a top surface and a bottom surface opposite the top surface, said user interface comprising:
a plurality of primary keys for accessing primary functions of the audio book player, said primary keys disposed in a primary zone of the top surface of the audio book player;
a plurality of secondary keys for accessing secondary functions of the audio book player, said secondary keys disposed in a secondary zone of the top surface of the audio book player; and
a tactile separation element separating the primary zone from the secondary zone of the audio book player.

2. The user interface for an audio book player according to claim 1, wherein the primary zone is located in a lower portion of the top surface of the audio book player.

3. The user interface for an audio book player according to claim 1, wherein the primary zone is located below said secondary zone.

4. The user interface for an audio book player according to claim 1, wherein the plurality of primary keys comprises a Play/Stop key, Rewind key and Fast Forward key.

5. The user interface for an audio book player according to claim 4, wherein the plurality of primary keys further comprises at least one of a Power ON/OFF key, Volume Down key, Volume Up key, and Sleep key.

6. The user interface for an audio book player according to claim 5, wherein the Power ON/OFF key is located in an upper left corner of the primary zone, the Volume Down and Volume Up keys are located one above the other on a right side of the primary zone, the Rewind, Play/Stop, and Fast Forward keys are arranged in a line at a bottom of the primary zone, and the Sleep key is located above the Play/Stop key.

7. The user interface for an audio book player according to claim 1, wherein the plurality of secondary keys comprises at least one of a Tone Down key, Tone Up key, Speed Down key or Speed Up key.

8. The user interface for an audio book player according to claim 7, wherein the Tone Down and Tone Up keys are located one above the other on a left side of the secondary zone, the Speed Down and Speed Up keys are located one above the other on a right side of the secondary zone.

9. The user interface for an audio book player according to claim 7, wherein the plurality of secondary keys further comprises at least one of a Bookmark key, Navigation Menu key, Previous key, Next key or Information key.

10. The user interface for an audio book player according to claim 9, wherein the Tone Down and Tone Up keys are located one above the other on a left side of the secondary zone, the Speed Down and Speed Up keys are located one above the other on a right side of the secondary zone, the Previous, Navigation Menu, and Next keys are arranged in a line at a bottom of the secondary zone, the Bookmark is located at a right bottom corner of the secondary zone, and the Information key is located at the left bottom corner of the secondary zone.

11. The user interface for an audio book player according to claim 1, wherein the plurality of primary keys and the plurality of secondary keys are raised with respect to the top surface of the audio book player.

12. The user interface for an audio book player according to claim 1, wherein each of the primary keys is defined by a specific tactilely-recognizable shape, said specific tactilely-recognizable shape corresponding to a primary function associated with the corresponding primary keys or to a secondary function associated with the corresponding secondary keys.

13. The user interface for an audio book player according to claim 12, wherein a number of the primary keys further comprise a raised ridge on a surface thereof.

14. The user interface for an audio book player according to claim 13, wherein said raised ridge outlines the specific tactilely-recognizable shape of a corresponding key or a portion thereof.

15. The user interface for an audio book player according to claim 1, further comprising a label associated with one of the primary keys or secondary keys.

16. The user interface for an audio book player according to claim 15, wherein said label is a tactile label, said tactile label comprising a raised symbol or recessed symbol.

17. The user interface for an audio book player according to claim 15, wherein said label is a tactile label, said tactile label comprising Braille symbols or visually-recognizable information.

18. The user interface for an audio book player according to claim 1, wherein the primary keys and the secondary keys each have a specific color, said specific color corresponding to a function associated with each of the primary and secondary keys.

19. The user interface for an audio book player according to claim 18, wherein the specific color of each of the primary keys is brighter as compared to the specific color of each of the secondary keys.

20. The user interface for an audio book player according to claim 1, wherein the primary keys all have a same specific color and the secondary keys all have a different same specific color thereby visually distinguishing said primary keys from said secondary keys.

21. The user interface for an audio book player according to claim 1, wherein the tactile separation element is a raised ridge protruding from the top surface of the audio book player or a recessed ridge in the top surface of the audio book player.

22. The user interface for an audio book player according to claim 1, wherein the tactile separation element has a tactilely smooth surface or a tactilely textured surface.

23. The user interface for an audio book player according to claim 1, wherein the tactile separation element extends across a central portion of the top surface of the audio book player, the secondary zone being located in an upper portion of the top surface above the tactile separation element and the primary zone being located in a lower portion of the top surface below the tactile separation element.

24. The user interface for an audio book player according to claim 1, wherein the tactile separation element extends across an entire width of the top surface of the audio book player, the secondary zone being located in an upper portion of the top surface above the tactile separation element and the primary zone being located in a lower portion of the top surface below the tactile separation element.
